(19) United States
(12) Patent Application Publication
(10) Pub. No.: US 2026/0236974 A1
(43) Pub. Date: Aug. 13, 2026

(54) INFRASTRUCTURE FOR DIGITAL, VIRTUAL AND LOCAL CONCIERGE

(71) Applicant: Dell Products L.P., Round Rock, TX (US)

(72) Inventors: Michael Robillard, Shrewsbury, MA (US); Xuebin He, Westwood, MA (US); Yichun Xu, Everett, MA (US)

(21) Appl. No.: 19/052,853

(22) Filed: Feb. 13, 2025

(51) Int. Cl. G06Q 30/0601; G06F 3/16; G10L 13/02

(52) U.S. Cl. CPC G06Q 30/0631; G06F 3/167; G06Q 30/0643; G10L 13/02

(57) ABSTRACT

A virtual concierge that implements a method including capturing, at an edge device, spoken input from a user, converting the input to text, transmitting the text to a server, receiving, from the server, a response corresponding to the input, converting the response to speech, and presenting the speech, in audible form, to the user. The server uses an LLM to generate the response, which may include a recommendation, and the speech is presented to the user by an avatar displayed at the edge device.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to digital assistants. More particularly, at least some embodiments relate to systems, hardware, software, computer-readable media, and methods for an infrastructure for digital, virtual and local concierge.

### BACKGROUND

Digital assistants such as chatbots such as have come into widespread use by a variety of different business. While such digital assistants have shown promise, there remain some problems in this field. For example, digital assistants typically lack the ability to gather, and use, a range of customer contextual information. As another example, conventional approaches suffer from latency problems, which can be frustrating for a customer who needs help in a timely manner.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an architecture, according to one embodiment.

FIG. 2 discloses an example of a face map, according to one embodiment.

FIG. 3 discloses aspects of a method, according to one embodiment.

FIG. 4 discloses aspects of a computing entity configured, and operable, to perform any of the disclosed methods, processes, and operations, according to one embodiment.

### DETAILED DESCRIPTION OF SOME EXAMPLE EMBODIMENTS

Embodiments disclosed herein generally relate to digital assistants. More particularly, at least some embodiments relate to systems, hardware, software, computer-readable media, and methods for an infrastructure for digital, virtual and local concierge.

One or more embodiments comprise a method and/or architecture, collectively a schema, for a virtual assistant. An embodiment may be employed in an edge environment that may enable advantageous use of a distributed computing approach, such as to reduce latency and thereby improve a user experience, for example. Example edge devices such as may be employed in an edge environment include, but are not limited to, mobile phones, webcams, computers, IoT (internet of things) devices, and any other systems and devices that a human may use to interact with a computing system and its components. An edge device may comprise hardware and/or software.

A method according to one example embodiment may be performed by an edge device and a central server. One such method may comprise operations including: prompting a user for input; capturing, using a device, such as webcam, associated with the edge device, spoken input from the user; converting, at the edge device, audio of the spoken input into text; by a LLM (large language model) running at a server that communicates with the edge device, receiving the text and generating a text response; synthesizing speech that comprises an articulation of the text response; and, by a speaking avatar hosted at the server, presenting the speech in audible form to the user.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that customer sensing processes and devices may be used to facilitate a more realistic interaction between a virtual assistant and a user than is provided by conventional approaches. An embodiment may employ an edge-based compute approach to reduce latency in virtual assistant response time. Various other advantages of one or more example embodiments will be apparent from this disclosure.

### A. Context for one or more embodiments for one embodiment

The following is a discussion of aspects of a context for various embodiments. This discussion is not intended to limit the scope of the claims or this disclosure, or the applicability of the embodiments, in any way.

### A.1 Introduction

The retail industry is undergoing a profound transformation driven by rapidly changing consumer preferences, technological advancements, and increasing competition. To remain relevant and competitive in this dynamic landscape, retail enterprises face the challenge of finding innovative ways to engage customers, reduce transactional friction, enhance their shopping experiences, build their brands, and drive business transformation.

This disclosure encompasses a variety of areas. These include, but are not necessarily limited to: customer service efficiency optimization utilizing interactive store concierge; promotion of customer experience based on concierge equipped with large language model (LLM) and animated avatar; business optimization using edge computing devices and local server; and, collection of data, processing of data, and the generation of information useful for creating data network effects for the improvement of generative AI systems.

One or more embodiments may involve what are sometimes referred to as data network effects. For example, processes, infrastructure, and algorithms may be used to generate data network effects. A data network effect refers to the situation where the value of a system increases as more data accumulates within it. Realistic creation of data network effects may be attained by automatically capturing and processing contextualized. Data network effects are commonly leveraged in generative AI systems.

Generative AI requires large datasets that must be kept fresh through back-and-forth customer interactions, such as with a virtual assistant for example. To remain competitive, an AI operator must corral data, analyze it, offer predictions, and then seek feedback, such as from one or more users, to sharpen subsequent suggestions. The value of generative AI systems depends on the data that is automatically collected from users. The generative AI system performance—its ability to accurately predict and suggest — thus hinges on the economic principle referred to as data network effects.

Useful bits of data, such as may be generated and employed in a generative AI system, can be found everywhere. As an example, data may come from interactions with buyers, suppliers, and coworkers. A retailer, for example, could track how consumers interacted with digital, virtual, and local concierge technology. These minute, seemingly trivial, details can vastly improve the predictions of a generative AI system. This data need not necessarily be sourced from humans pounding keyboards. Such data may, instead, be sensed and gathered using devices and sensors such as microphones, cameras, and other high-resolution sensors, and processed using “Distributed ML” or “Field AI” on tailored infrastructure.

Thus, one or more embodiments comprise approaches for creating and using an infrastructure for digital, virtual, and local concierge services. More particularly, one or more embodiments may comprise processes, infrastructure, and algorithms that may be used to generate data network effects that serve to improve the predictions and performance of generative AI systems.

### A.2 Example aspects of various embodiments

It is expected that immersive technology will become a key enabler of business transformation because it enables humans to interact with business information persisted in datastores, machinery represented as digital twins, and artificial intelligence easily and as equals. We call this idea the immersive enterprise. This disclosure defines an immersive enterprise as a business that leverages immersive technology to perform business transformation. This idea is aligned with what some in the industry define as spatial computing.

Within spatial or immersive environments, other ability to model and improve business processes is only constrained by the processing capabilities of the underlying infrastructure. Thus, an embodiment can leverage real-world physics, or not. An embodiment may make a simulated environment track real time operations or replay the past. Historical analysis, exploratory planning, and new product introduction all become easier. Having these capabilities available to the average business has never happened before. It has the potential to dramatically improve businesses and to reduce transactional friction.

One example embodiment, discussed elsewhere herein, is focused on the retail vertical. However, it is noted that the concepts disclosed herein are largely transferable or applicable to other verticals.

### B. Detailed discussion of aspects of one or mor embodiments

### B.1 virtual assistants

Virtual assistants, such as chatbots for example, are transforming the landscape of client service within the retail industry. These intelligent solutions, empowered by artificial intelligence (AI) and natural language processing (NLP), exhibit the ability to swiftly comprehend and respond to client inquiries. Virtual assistants are accessible round-the-clock, aiding with tasks like product recommendation and price check. By doing so, virtual assistants boost client satisfaction while simultaneously relieving the workload of human customer support staff and saving budget for the retail store.

One advantage of employing virtual assistants in the retail sector is their capacity to offer tailored recommendations. These digital aides possess the capability to discern individual preferences and formulate personalized product suggestions. This is accomplished by analyzing client data and historical purchase information. Whether through text-based chat interfaces or voice interactions, these assistants guide consumers through the vast array of available products, ultimately facilitating more informed purchasing decisions. Personalization plays a pivotal role in boosting customer loyalty and increasing the likelihood of repeat business.

The widespread adoption of virtual assistants in the retail sector has reshaped customer engagement, resulting in a revamped approach to customer service characterized by personalized guidance, streamlined inventory management, and a seamless omnichannel shopping experience. These intelligent digital tools are revolutionizing the way customers interact with businesses, providing customized assistance and enhancing the overall shopping journey. Virtual assistants, ranging from text-based chatbots to voice-activated counterparts, have become indispensable components of the retail landscape. Their presence not only augments operational efficiency but also fosters stronger connections with consumers.

In a similar vein, a digital concierge operates as an AI (artificial intelligence) platform or ML (machine learning) platform that harnesses natural language processing to address customer inquiries and deliver contactless shopping experiences that replicate the feel of a physical store. These digital concierge services offer recommendations, answer queries concerning product availability, pricing, inventory status, and other pertinent details, thereby simplifying the online shopping process.

Virtual concierge services closely resemble human personal assistants, offering real-time guidance and advice to customers throughout their shopping journeys. Typically facilitated by actual experts who serve as guides, personal shoppers, and consultants, these services play a pivotal role in assisting customers in making informed purchase decisions. Virtual concierge services can proactively provide timely product recommendations, extend special offers, and even engage customers with personalized advice.

There are various other virtual assistant platforms currently, including Amazon Just Walk Out, Amazon Smart Grocery Carts, Walmart Smart Check Out, and the Walmart Intelligent Retail Lab. By way of contrast with these platforms however, one or more embodiments may leverage features and aspects such as customer sensing, including mouth movement detection for example, edge-based compute operations, and low latency local display technology, such as graphics generation and display.

### B.2 Discussion

### B.2.1 Overview

One or more embodiments may have various capabilities, although no embodiment is required to have any particular capability, or capabilities. Some example capabilities of one or more embodiments include, but are not limited to:

1. [PROCESS, INFRA, ALGO] The LLM in the concierge can answer questions for users. The users can request handoff to remote human agent and/or in-store agent for assistance under circumstances that the LLM fulfill users’ tasks.

2. [PROCESS, INFRA, ALGO] The concierge microphone is controlled by detected movement of the lips of the user. In an embodiment, audio is only captured and processed when the user’s mouth is open, indicating that the user is the one who is speaking.

3. [PROCESS, INFRA, ALGO] An animated digital avatar, generated by local compute, and presented at a display of an edge device for example, may be employed in an embodiment. Besides the capability of presenting multiple different facial expressions, this avatar can also track the user’s face and in an embodiment, the avatar always faces the customer while the user is speaking, which provides an immersive conversation experience similar to what a human might experience in speaking with another human.

4. [PROCESS, INFRA, ALGO] In an embodiment, all elements except for the LLM of the virtual assistant, may be running on local edge computing devices, which is highly efficient, and can help to reduce data transfer and associated latency problems. The LLM, on the other hand, may run on a local server in communication with the edge devices, assuring high level security and fast data transfer.

5. [PROCESS, INFRA, ALGO] One embodiment combines a digital, that is, an LLM-based, virtual (remote human), and local (local human) concierge service. An embodiment includes processes for controlling the interaction of these three entities and providing context amongst them leveraging a local display, remote display, and a local mobile phone.

As suggested in the section above, and elsewhere in this disclosure, an embodiment comprises three levels of assistance, namely, LLM, remote human, and local human agent. Initially an AI bot (LLM) will assist the user. If the AI bot is not enough, it will hand off to remote human agent. If still not enough, it will call on-site human agent to help. By way of contrast, most conventional assistance systems have only a single layer of assistance.

### B.2.2 Aspects of an example architecture

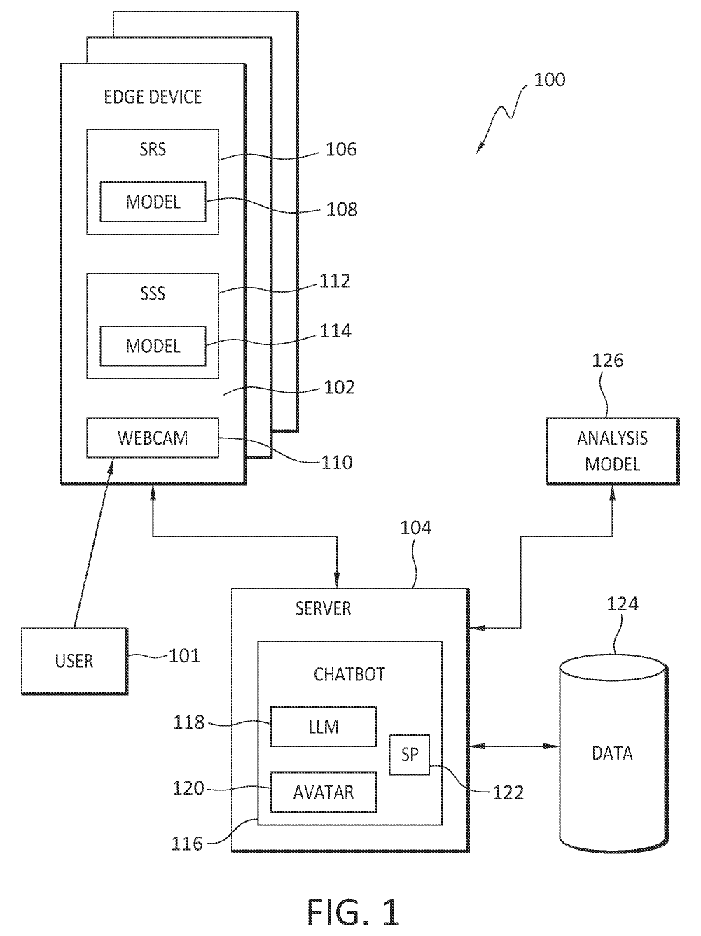

With attention now to FIG. 1, an example architecture 100 according to one embodiment is disclosed. The architecture 100 may interface with a user 101 and comprise various edge devices 102 each configured and operable to communicate with a server 104. Each of the edge devices 102 may comprise an instance of a speech recognition service (SRS) 106 that chat comprises a model 108, such as an AI model, that is configured and operable to translate queries, spoken by the user 101 and captured by a webcam 110 and/or other sensors, into text. The edge device 102 may further comprise a speech synthesis service 112 that comprises a model 114 configured and operable to convert a response received from the server 104, to a verbal answer to a user query, using a speaker that may be integrated into the webcam 110.

The server 104 may comprise a chatbot, or other virtual assistant, 116. The chatbot 116 may comprise an LLM 118, which may receive queries captured by a microphone of the webcam 110, and generate responses to the queries. The chatbot 116 may also comprise an avatar 120 that may be displayed at the edge device 102. Finally, the chatbot 116 may comprise a shape predictor (SP) model 122 that is able to identify, based on input from the webcam 110, a location and orientation of the face of the user 101, and adjust the avatar 120 accordingly.

With continued reference to FIG. 1, a database 124 may be provided that is accessible by the server 104. The database 124 may store logs and other information and data obtained by the server 104 in connection with its interactions with the edge devices 102 and associated users. In an embodiment, logs generated and maintained by the server 104 may be provided as input to an analysis model 126 for evaluation, for example, of user inputs, and corresponding responses generated by the chatbot 116.

With regard to the components of the architecture 100, the scope of this disclosure is not limited to the disclosed functional allocations and hosting arrangements. For example, in an embodiment, the avatar 120 may be hosted at the edge device 102. As another example, the SP model 122 may be hosted at the edge device 120. Thus, the configuration and arrangement disclosed in FIG. 1 is provided only by way of example and is not intended to limit the scope of this disclosure, or of any claims, in any way. Further information concerning the various components disclosed in FIG. 1 is provided in the discussion below.

### B.2.3 Operational aspects of one or more embodiments

Following is a discussion of some operational aspects of one or more example embodiment, such as of a virtual concierge service. These are provided only by way of example.

1. An edge device 102 hosts a speech recognition service 106 that enables customers to pose questions. The edge device microphones, which may or may not be integrated into the webcam 110, capture the queries and transmit them to an NLP model 118, which generates recommendations. The response including the recommendations is then channeled through a speech synthesis service 112, utilizing a speaker to verbalize the answer.

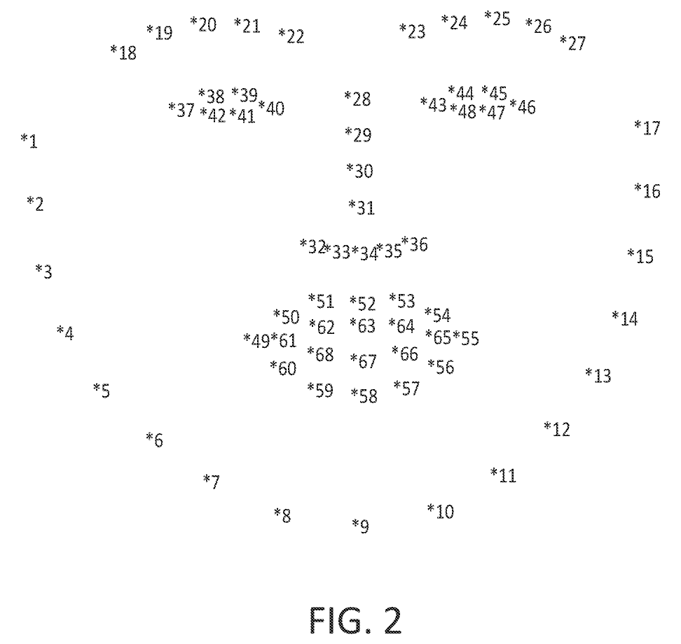

2. A webcam 110 is mounted to capture lip movements of the user 101. Each frame captured by the webcam 110 will be processed with an AI model 122, such as the Shape Predictor model for example, which maps 68 dots to different spots on a human face, as shown in the example map 200 in FIG. 2. Then, an embodiment may calculate the ratio value of mouth height divided by mouth width. If the ratio value passes a certain threshold, an embodiment may identify the mouth as open and an indication that the user 101 is speaking. In an embodiment, the processing of audio to text is only initiated when the mouth of the user 101 is open, so that the microphone does not capture any background voice that is not from the mouth of the user 101.

3. In one embodiment, the speech recognition service 106 employs an AI model 108 from OpenAI named ‘whisper-large-v2,’ which converts spoken language from audio into text.

4. The LLM 118, which may comprise the “Llama2” model, functions as a recommender system, addressing queries received from the speech recognition model 108. This implementation of the LLM 118 is a 13 billion parameter language model which may be deployed on premise. In one embodiment, the LLM 118 may run on a Dell R760 server, which has two A30 GPUs. The LLM 118 may be adjusted to answer questions in a way that the developers want. For example, an embodiment may set the LLM 118 to be a Dell sales assistant. In that way, when the LLM 118 is asked to help with laptop recommendations, the LLM 118 will not recommend any laptops that are not from Dell.

5. A third model 114 may comprise the “tecotron 2” model from Coquiai, specializing in speech synthesis based on the textual input it receives from the LLM 118. In an embodiment, the model 114, which may be an element of the speech synthesis service 112, runs on the same edge device 102 as the speech recognition model 108.

6. In an embodiment, the communication within the speech processing pipeline (discussed at 1. through 5. above) may rely on the Socket.IO connection protocol, facilitating the exchange of data between the server 104 and client, or edge device 102.

7. An embodiment of a concierge service may comprise an avatar 120 that engages in speaking interactions with the user 101, thus providing the user 101 with a human assistant-like experience. Because, as suggested earlier, the frames captured by the webcam 110 are analyzed by the AI model 122, such as the Shape Predictor AI model that maps human faces, the computing hardware is able to identify the location of the face of the user 101. Thus, the avatar 120 is able to tilt itself and always facing the user 101, so as to mimic a real-life conversation.

8. An embodiment of the concierge service offers personalized recommendations and assists users 101 with their inquiries.

9. An embodiment may also maintains data logs, such as in the database 124 for example, forwarding the logs to the analysis model 126 for further analysis.

10. An embodiment may aid users 101 in self-checkout processes and can seamlessly transit to either remote human agent or in-store agent to provide in-person assistance if needed.

### C. Further discussion

As set forth in this disclosure, one or more embodiments may possess various useful features and aspects, although no embodiment is required to possess any of such features and aspects. The following examples are illustrative, but not exhaustive.

An embodiment may facilitate, for example, the business transformation of a retail store through the creation and use of a virtual assistant endowed with speech recognition and speech synthesis capabilities. One or more embodiments of a virtual assistant may possess various capabilities.

A concierge may capture spoken audio and to generate answers in audio allow the LLM to assist customers in a human-like manner, thus significantly boosting user experiences. Those capabilities are combined together to form a unique concierge system.

An input prompt and/or the fine-tuning equip an LLM with proficiency in constructing recommender systems based on distinct characteristics. For example, a Dell sales assistant only recommends laptops from Dell, thereby furnishing pertinent recommendations to a user.

An LLM based chatbot offers tailored recommendations, drawing from historical interactions with the user. Likewise, the newly generated answers are captured and logged into the chat history for subsequent analysis. In comparison with an embodiment, most conventional chatbots generate sentences only based on the latest user input; they cannot take chat history as a reference as our chatbot does. Although some of them do capture chat history, the history serves as a transcript proof of the conversation, rather than serve any analysis purposes.

With face tracking, the avatar according to an embodiment always faces the customer while talking. Accordingly, the communication between the customer and the avatar is in a manner resembling human conversation, creating a lifelike dialogue.

An embodiment may include the ability to guide customers through self-checkout processes. This may help to improve the customer experience. As well, an embodiment may include the ability to progress through various customer engagement stages before seamlessly transitioning, or handing off, to a human assistant.

In an embodiment, the audio capture initiated by lip movement detection may ensure that any background voices/noises are not captured, and only relevant content, namely, words spoken by the user, are captures. Thus, an embodiment may employ a lip movement tracking function to control the audio intake system.

In an embodiment, many, or most, parts of a virtual concierge system – including face mapping, lips movement capturing, audio to text conversion, and text to audio conversion – are deployed on low-power, yet high-efficiency, edge devices. This not only saves cost, but also saves bandwidth and reduces latency.

In an embodiment, the LLM is deployed on a local server. This approach may help to guarantee security and may shorten the data transition time, that is, the time it takes data to transit between the local server and one or more edge devices.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

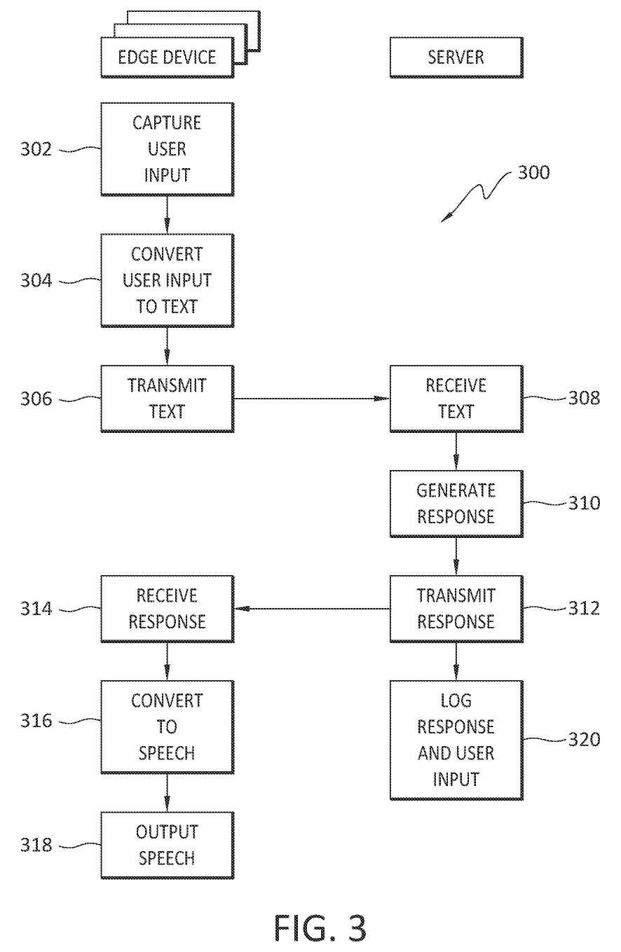

Directing attention now to FIG. 3, a method 300 according to one embodiment is disclosed. As shown, aspects of the method 300 may be performed by one or more edge devices, and a server. The disclosed functional allocation is presented by way of example, and may have a different form in another embodiment.

The example method 300 may begin when a edge device captures 302 spoken human user input. The capture 302 may be performed using a sensor such as a microphone. The microphone may or may not be an element of another device such as a webcam.

The audible input provided by the user may be stored, and converted 304 to text. The text may be stored as well at the edge device. The text may then be transmitted 306 to the server.

After receipt 308 of the text, the server may then generate 310 a response, such as a recommendation, to the user query embodied by the text. Generation 310 of the response may be performed by an LLM running on the server. The response may then be transmitted 312 back to the edge device.

At the edge device, the response received 314 from the LLM of the server may then be converted 316 to audible speech. This audible speech, which may then be output 318, may be synchronized with movements of an avatar that is able to determine a position of the face of the user to whom the response is directed.

During, and/or after, performance of the method 300, the server may log 320 the query received from the user, as well as the response sent to the user concerning the query. The logged information may be used later to increase the size of the dataset used by an LLM of the server to generate responses to user queries.

### E. Example use cases

Following are some example use cases for one or more embodiments. These are presented by way of illustration and are not intended to limit the scope of this disclosure, or any claims, in any way.

### E.1 Example 1 - Answer customers questions in a retail store in an efficient and cost saving approach

Different customers usually ask a series of similar questions, which are in general related to product features, functions, delivery, and so on. It is true that the company can train their employees to answer those questions; however, this innovative solution lowers the company expenditure on several aspects. First, the training costs more than using an LLM. Not to mention when the current employees leave their jobs, the company has to spend on the same training repetitively. Second, with the concierge helping the customer, the human agent can spend time on more valuable or human-demanding work. What is more, when a customer has questions particularly related to a product, the chatbot can answer the questions almost in real time as it already logged with all the product information, comparing to human assistants may have to look them up, which takes more time. The near real time response can elevate customer satisfaction level, thus increasing the likelihood that customers will make purchases.

Moreover, the lips movement capture function determines that the microphone captures audio only from the customer using the concierge. This function assures that the background voice from other people is not captured, thus further guaranteeing that an embodiment can work in noisy environments. In such a sense, a retail store is a especially suitable application scenario for an embodiment.

Even if the customer is not satisfied with the LLM, there are still back-up plans, which are transferring to a remote human agent, or transferring to a local store employee to help. Thus, an embodiment can cover almost all customer inquiries and can fulfill the tasks in an efficient approach.

### E.2 Example 2 - Ease the check-out process:

Customer service expectations are higher than ever before, which means more responsibilities for the role of store associate. Once a customer has chosen their desired product, a virtual shopping assistant can help them complete the check-out process.

If the customer is shopping for something that he/she cannot directly take to check out – for example, large appliances such as TVs, or valuable products locked in a cabinet – an embodiment may ease the whole checkout process. Conventionally, the customer needs to fetch store employees to help get the item, and then take the item to the checkout line. If it is a large item, there could be even more incontinence as the customer has to carry the bulky item while waiting in line. In one embodiment, since the concierge is also connected to the store employee phone device through socket IO, once the customer decided to check out, the concierge will emit a message to the employee, asking them to bring the product to the customer. In this way, it shortens the time needed for the customer to check out as well as providing a more convenient shopping experience.

### E.3 Example 3 – Hotel front desk

The usage of the interactive concierge includes but is not limited to retail store scenarios. Another use case is the front desk. The front desk staff routinely help people with similar questions, such as directions, hours, and entry passes. As suggested earlier, the large language model can be fine-tuned/prompted to perform task with pre-defined characteristics/titles, they can also act as the front desk staff for different industry, ranging from enterprise front desk staff to hotel reception.

### E.4 Example 4 – Exhibition demo booth

In some presentation events, there are multiple booths belonging to different companies or organizations. For each booth, presenters demonstrate their products or solutions while guests walk into their booth. However, a human presenter cannot present continuously for a few hours without rest. Moreover, the presenters need to present the same idea numerous times and answer similar questions in Q&A. With the interactive virtual concierge taking over most of the chores, the presenters do not need to perform the repetitive tasks. Instead, the presenters can focus on answering questions that the LLM cannot handle and having constructive conversations with the listeners. Additionally, sometimes the organization will send two or more people to present in their booth so that their employees can take turns to rest, or to have lunch. The employment cost multiplies according to the number of employees needed. On the contrary, the LLM in an embodiment of the concierge service can work 24 hours a day.

### E.5 Example 5 – Personal assistant

In an embodiment, a virtual concierge can be implemented in a device mounted with wheels so that it can work as a personal assistant at home. For example, a user can connect the virtual concierge to different smart appliances such as AC, and TV. So that the user does not need to use different mobile app for different appliances, an embodiment of the virtual concierge may assist a user in controlling all the appliances. The user can speak to the virtual concierge, as a user might to Apple Siri ®, to ask the assistant to adjust room temperature or turn up TV volume, for example. As another example, an embodiment may provide convenience when the user is not comfortable using touch screens. For example, when the user is cooking, he/she can have the virtual concierge set aside, and ask the virtual concierge to show the recipe/videos during cooking, so that the user can avoid touching the screen with dirty hands.

### F. Further Example Embodiments

Following are some further example embodiments. These are presented only by way of example and are not intended to limit the scope of this disclosure or the claims in any way.

Embodiment 1. A method, comprising: capturing, at an edge device, spoken input from a user; converting the input to text; transmitting the text to a server; receiving, from the server, a response corresponding to the input; converting the response to speech; and presenting the speech, in audible form, to the user.

Embodiment 2. The method as recited in any preceding embodiment, wherein the spoken input is captured by a microphone at an edge device.

Embodiment 3. The method as recited in any preceding embodiment, wherein the user input is converted to text using a speech recognition AI (artificial intelligence) model.

Embodiment 4. The method as recited in any preceding embodiment, wherein the response is generated by an NLP (natural language processing) LLM (large language model) at the server.

Embodiment 5. The method as recited in any preceding embodiment, wherein the response is converted to the speech by a speech synthesis model.

Embodiment 6. The method as recited in any preceding embodiment, wherein the speech is presented to the user by a speaking avatar displayed on the edge device.

Embodiment 7. The method as recited in embodiment 6, wherein movements of the avatar are controlled by a shape predictor model that uses a webcam of the edge device to detect lip movements of the user.

Embodiment 8. The method as recited in embodiment 6, wherein the avatar is controlled in such a way that the avatar faces the user when the user is speaking.

Embodiment 9. The method as recited in any preceding embodiment, wherein the response comprises a recommendation that is based in part on a history of interactions in which the user has participated.

Embodiment 10. The method as recited in any preceding embodiment, wherein a log is maintained that comprises the response, and other responses, as well as inquiries from the user that caused the responses to be generated.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

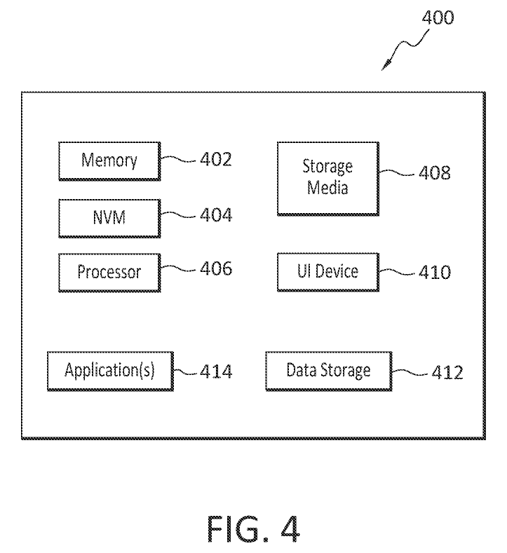

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
capturing, at an edge device, spoken input from a user;
converting the input to text;
transmitting the text to a server;
receiving, from the server, a response corresponding to the input;
converting the response to speech; and
presenting the speech, in audible form, to the user.

2. The method as recited in claim 1, wherein the spoken input is captured by a microphone at an edge device.

3. The method as recited in claim 1, wherein the user input is converted to text using a speech recognition AI (artificial intelligence) model.

4. The method as recited in claim 1, wherein the response is generated by an NLP (natural language processing) LLM (large language model) at the server.

5. The method as recited in claim 1, wherein the response is converted to the speech by a speech synthesis model.

6. The method as recited in claim 1, wherein the response comprises a recommendation that is based in part on a history of interactions in which the user has participated.

7. The method as recited in claim 1, wherein a log is maintained that comprises the response, and other responses, as well as inquiries from the user that caused the responses to be generated.

8. The method as recited in claim 1, wherein the speech is presented to the user by a speaking avatar displayed on the edge device.

9. The method as recited in claim 8, wherein movements of the avatar are controlled by a shape predictor model that uses a webcam of the edge device to detect lip movements of the user.

10. The method as recited in claim 8, wherein the avatar is controlled in such a way that the avatar faces the user when the user is speaking.

11. A non-transitory storage medium having stored therein instructions that are executable by one or more hardware processors to perform operations comprising:
capturing, at an edge device, spoken input from a user;
converting the input to text;
transmitting the text to a server;
receiving, from the server, a response corresponding to the input;
converting the response to speech; and
presenting the speech, in audible form, to the user.

12. The non-transitory storage medium as recited in claim 11, wherein the spoken input is captured by a microphone at an edge device.

13. The non-transitory storage medium as recited in claim 11, wherein the user input is converted to text using a speech recognition AI (artificial intelligence) model.

14. The non-transitory storage medium as recited in claim 11, wherein the response is generated by an NLP (natural language processing) LLM (large language model) at the server.

15. The non-transitory storage medium as recited in claim 11, wherein the response is converted to the speech by a speech synthesis model.

16. The non-transitory storage medium as recited in claim 11, wherein the response comprises a recommendation that is based in part on a history of interactions in which the user has participated.

17. The non-transitory storage medium as recited in claim 11, wherein a log is maintained that comprises the response, and other responses, as well as inquiries from the user that caused the responses to be generated.

18. The non-transitory storage medium as recited in claim 11, wherein the speech is presented to the user by a speaking avatar displayed on the edge device.

19. The non-transitory storage medium as recited in claim 18, wherein movements of the avatar are controlled by a shape predictor model that uses a webcam of the edge device to detect lip movements of the user.

20. The non-transitory storage medium as recited in claim 18, wherein the avatar is controlled in such a way that the avatar faces the user when the user is speaking.
